(19) United States
(12) Patent Application Publication
(10) Pub. No.: US 2018/0174226 A1
(43) Pub. Date: Jun. 21, 2018

(54) PRE-EMPTIVE ITEM PACKAGING

(71) Applicant: Amazon Technologies, Inc., Reno, NV (US)

(72) Inventor: Jong Hwa Yoon, Seattle, WA (US)

(73) Assignee: Amazon Technologies, Inc., Reno, NV (US)

(21) Appl. No.: 14/031,895

(22) Filed: Sep. 19, 2013

(51) Int. Cl. G06Q 30/06; G06Q 10/08

(52) U.S. Cl. CPC G06Q 30/0635; G06Q 10/083

(57) ABSTRACT

Processes for receiving, packaging and/or processing orders for items offered by an electronic marketplace are described, including methods whereby certain products of interest may be identified and subjected to alternative inbound and/or outbound processing that omit certain steps used in similar processes. A first inbound process may include steps related to shelving, or otherwise storing, received products, prior to packaging such products for mailing and delivery to consumers. In some examples, a second inbound process may omit one or more of the shelving/storing steps from the first inbound process, and pre-package the received product for mailing.

### BACKGROUND

Methods of rapidly delivering products to consumers via online catalogues, ordering systems and delivery services have continued to advance to the point where customers can routinely order selected products, request expedited shipping and receive a product within a few days of placing the order. However, there are still some situations in which consumers may prefer to purchase certain products from a local retailer, such as impulse purchases or where expedited shipping may add undesirable costs to the purchase. Typically, a facility handling online order fulfillment may store a plurality of products offered for sale, and may process a customer order by packaging the products included in the customer order, specifying shipping instructions and labeling the package with the customer address.

### BRIEF DESCRIPTION OF THE DRAWINGS

Various embodiments in accordance with the present disclosure will be described with reference to the drawings, in which:

FIG. 1 illustrates an example flow for describing techniques for pre-emptive item packaging as described herein, according to at least one example;

FIG. 2 illustrates another example flow for describing techniques for pre-emptive item packaging as described herein, according to at least one other example;

FIG. 3 illustrates an example architecture for implementing the pre-emptive item packaging techniques described herein, according to at least one example;

FIG. 4 illustrates another example architecture for implementing the pre-emptive item packaging techniques described herein, according to at least one other example;

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Embodiments of the present disclosure are directed to, among other things, providing techniques for enabling pre-packaging of one or more items of an electronic marketplace. In some examples, the electronic marketplace may be managed by one or more service provider computers (e.g., servers) that host electronic content in the form of an electronic catalog. Customers may access the electronic catalog to view, review, discuss, order, and/or purchase items (e.g., physical items that may be stored in a warehouse or other location) from the electronic marketplace. In some examples, different levels of membership may be offered to different customers, each level of membership potentially being associated with different ordering and/or shipping processes. Additionally, the electronic marketplace may provide (e.g., in digital form via the server and/or by arranging for the items to be physically shipped) items of different prices.

Embodiments of the present disclosure may include, among other things, processes for receiving, packaging and/or processing orders for items offered by an electronic marketplace, as mentioned above. In some examples, the electronic marketplace may support a number of different inbound and/or outbound processes for items, at least some of which may be implemented using less steps than similar processes. For example, a first inbound process may include steps related to shelving, or otherwise storing, received products, prior to packaging such products for mailing and delivery to consumers. In some examples, a second inbound process may omit one or more of the shelving/storing steps from the first inbound process, and pre-package the received product for mailing.

As used herein, a pre-packaging step may generally be understood as at least partially packaging a product for mailing and may include, for example, one or more of packing, boxing and/or sealing the received product in a mailing container of the electronic marketplace. In some examples, such “pre-packaging” steps may be performed before the individual product is associated with a purchasing consumer and/or before a purchase order for the individual product is processed. In some examples, a shipping label may be applied to a pre-packaged item after it is associated with a purchasing consumer and/or after a purchase order for the individual product is processed.

Additionally, in some aspects, a determination may be made as to whether a particular item offered by the electronic marketplace is a candidate for an abbreviated inbound and/or outbound process (such as a second inbound process) being implemented by less operations than for other inbound and/or outbound processes. In some examples, the determination may be based, at least in part, on one or more of item cost, item profit margin, item weight and/or item size. In some examples, the determination may be based, at least in part, on a machine learning algorithm.

Additionally, in some examples, metrics and/or projections related to those items determined to be candidates for the abbreviated inbound and/or outbound process may be further analyzed to determine whether to implement the abbreviated inbound and/or outbound process with respect to received items. For example, one or more of previous sales, expected sales, pre-orders, backorders, social media analytics or other criteria may be assessed (alone or in combination with other factors) to determine whether to flag the item (e.g. via a product number in the electronic marketplace processing service) for an abbreviated inbound and/or outbound process. However, it should also be noted that, in some example, such analysis may be performed before determining whether the item is a candidate for an abbreviated inbound process, an abbreviated outbound process and/or expedited shipping. For example, some examples may identify spikes in item sales, pre-orders, backorders and/or high levels of social media interest for a particular product, after which, the item may be assessed (e.g. based on profit margin, shipping costs, expected sales levels, etc.) to determine whether it is a suitable candidate for abbreviated processing and/or expedited shipping.

In some examples, potential future sales for those items determined to be candidates for the abbreviated inbound and/or outbound process may be identified based at least in part on a forecasting engine. In some examples, when the identified potential future sales of the particular item is below a threshold amount, a first inbound process may be implemented on instances of the particular item as the instances of the particular item arrive at a fulfillment center associated with the electronic marketplace, whereas when the identified potential future sales of the particular item is above the threshold amount, a second inbound process may be implemented on instances of the particular item as the instances of the particular item arrive at a fulfillment center associated with the electronic marketplace.

In some examples, the threshold may be set statically or dynamically. In some examples, the forecasting engine may identify the potential future sales of the particular item based at least in part on public social media information.

In some examples, the operations for implementing the first inbound process may include receiving the items, identifying the items, stowing the items, picking the stowed items, and packaging the picked items. In some examples, the operations for implementing the second inbound process may include at least receiving the instances of the particular item and packaging the received instances of the particular item.

In some examples, the received instances of the particular item may be packaged as part of an automated process as the instances of the particular item arrive at a fulfillment center.

In some examples, an abbreviated inbound and/or outbound process may be applied to a limited number of the received instances of the particular item (which can be associated with expedited orders such as one or two day shipping).

In some examples, expedited shipping of the instances of the particular item may be enabled while the identified potential future sales of the particular item is above the threshold amount. In some examples, enabling the expedited shipping may include identifying the particular item with an identifier on a web page that distinguishes the item from other non-qualifying items (e.g. those items that are not candidates for the abbreviated process, or those that do not qualify based on the further metrics, projections and/or threshold analysis). In some embodiments, certain users may be presented with the expedited shipping option for a particular item, whereas other users may not be presented with the option.

Additionally, in some aspects, items that have already been received, which may have been subjected to one or more shelving/storage steps, may be determined to be eligible for pre-packaging, and may be withdrawn from shelving/storage prior to being associated with a particular customer order.

Additionally, in some aspects, a computer system may be configured to execute one or more processes, such as those discussed above and further herein. For example, a computer system may be configured to receive purchase history information associated with a plurality of items offered by an item provider, and/or generate forecasted purchase information for at least one item of the plurality of items offered by the item provider. In some examples, the forecasted purchase information may be based at least in part on the purchase history information. Additionally, in some examples, the system may determine a threshold amount of potential sales for at least a subset of the plurality of items. In some examples, the threshold amount may identify whether to enable an expedited shipping program.

Additionally, in some examples, the system may identify when the forecasted purchase information for an item exceeds the threshold amount, and implement an expedited shipping program for the item based at least in part on identifying that the forecasted purchase information for the item exceeds the threshold amount.

In some examples, the item provider may include an electronic marketplace configured to receive at least a subset of the plurality of items from a seller. In some examples, the subset of the plurality of items from the seller may be prepared for shipping prior to storing the items in a storage center associated with the electronic marketplace.

In some examples, the purchase history information may include a volume of purchases, time-limited historical sales information and/or backorder information for instances of each of a plurality of items.

In some examples, the forecasted purchase information may be generated based at least in part on social media information associated with the plurality of items. In some examples, the social media information may include at least public comments that identify the at least one of the plurality of items and/or may be gathered via a computer algorithm that automatically identifies comments associated with a particular item.

Further, in some examples, the threshold amount may be determined independently for at least two of, or each item, of the plurality of the items. In some examples, the threshold amount may be determined dynamically based at least in part on a shipping cost associated with each item, a shipping distance associated with each item, a cost of each item, a profit associated with each item, a weight of each item and/or a size of each item. In some examples, the expedited shipping program may include enabling guaranteed faster shipping to a customer at a same price as slower shipping.

In some examples, the expedited shipping program may include pre-packaging the at least one item prior to receiving an order for the at least one item.

Additionally, in some aspects, a computer system may be configured to receive purchase history information associated with an identifier that corresponds to a plurality of same commodity items. In some examples, the system may forecast a future purchase prediction for the identifier based at least in part on the purchase history information and social media information, and determine when the future purchase prediction identifies that the identifier has a demand above a threshold demand. In some examples, the system may prepackage at least a subset of the plurality of same commodity items for expedited shipping based at least in part on the demand being above the threshold demand.

Additionally, in some aspects, a computer-readable storage medium may be provided including computer-executable instructions that, when executed by one or more computer systems, configure the one or more computer systems to perform operations described herein.

The techniques described above and below may be implemented in a number of ways and in a number of contexts. Several example implementations and contexts are provided with reference to the following figures, as described below in more detail. However, the following implementations and contexts are but a few of many.

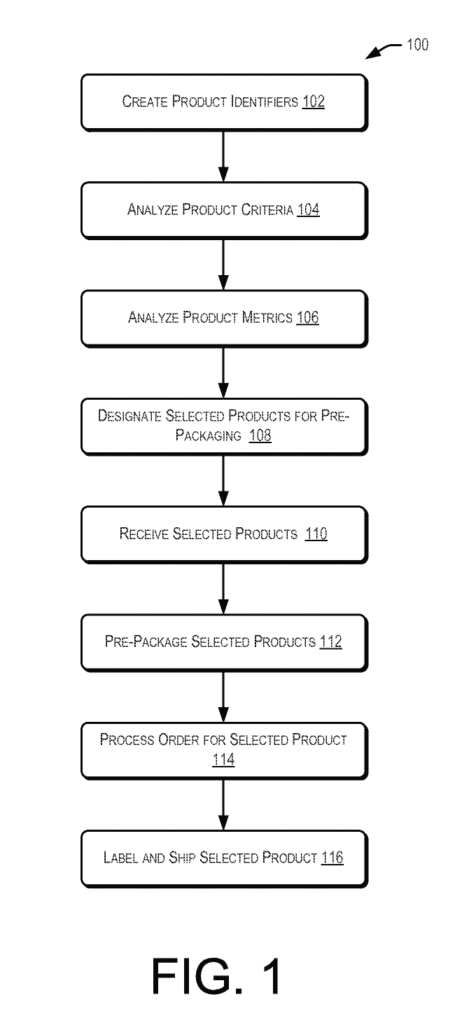

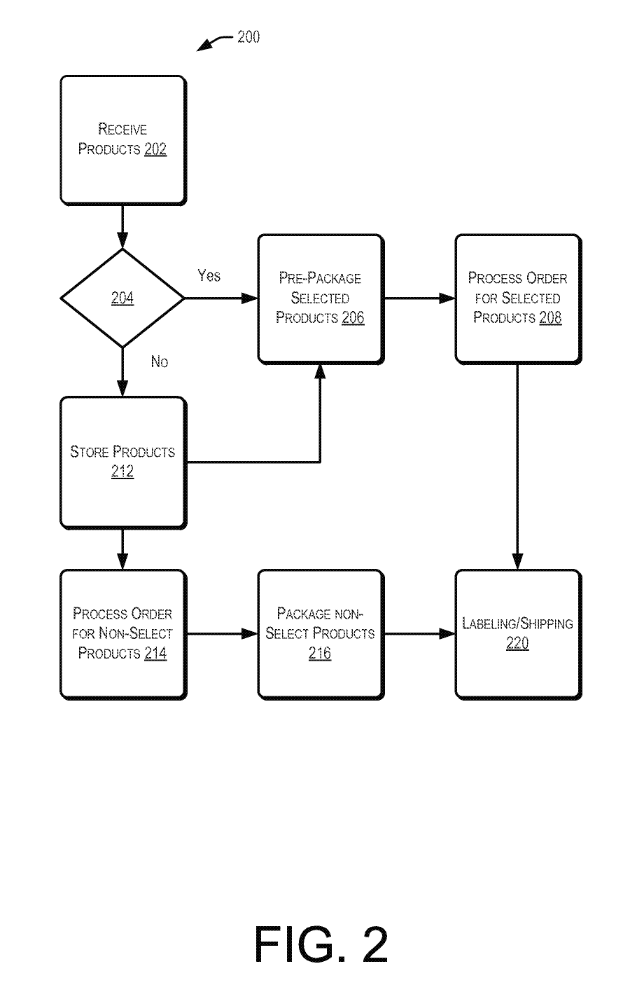

FIGS. 1 and 2 illustrate example flow diagrams showing respective processes 100 and 200 for implementing inbound/outbound processes as described herein. These processes are illustrated as logical flow diagrams, each operation of which may represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures and the like that perform particular functions or implement particular data types. The order in which the operations are described is not intended to be construed as a limitation, and any number of the described operations can be combined in any order and/or in parallel to implement the processes. Additionally, any specific reference to one or more operations being capable of being performed in a different order is not to be understood as suggesting that other operations may not be performed in another order.

Some, any, or all of the processes may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable storage medium, for example, in the form of a computer program comprising a plurality of instructions executable by one or more processors. The computer-readable storage medium may be non-transitory.

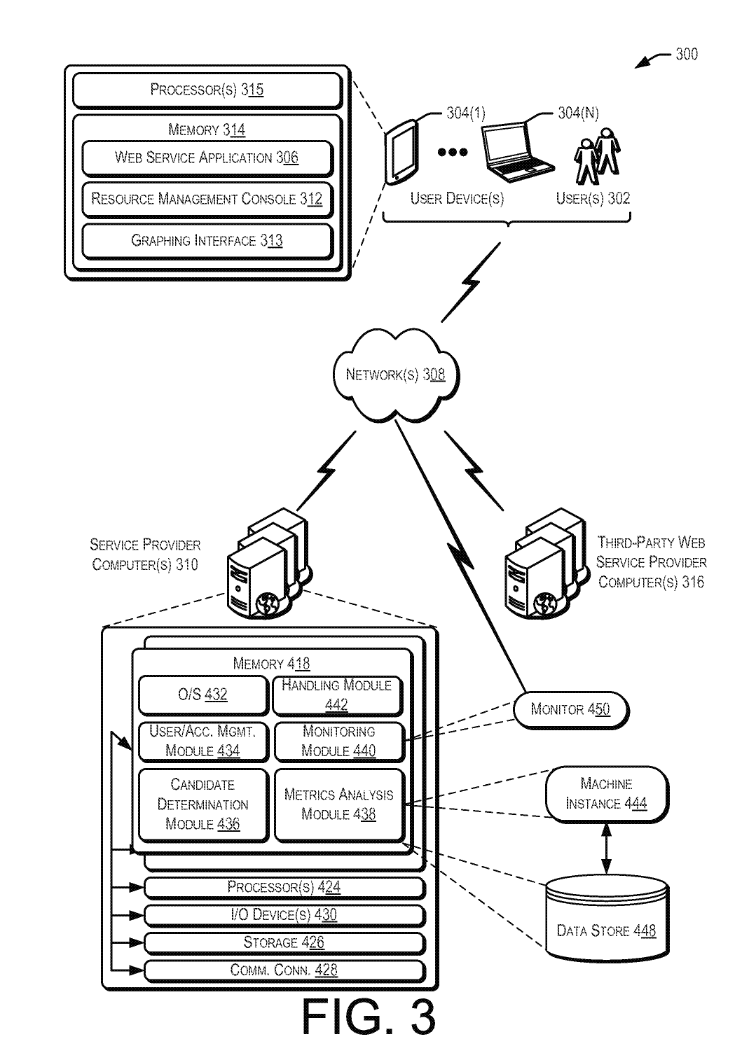

FIG. 1 depicts an illustrative flow 100 in which techniques for inbound and/or outbound processes may be implemented. Aspects of these techniques are described in more detail below in connection with at least FIGS. 2 and 3. Returning to FIG. 1, in illustrative flow 100, operations may be performed by one or more processors of one or more service provider computers and/or instructions for performing the operations may be stored in one or more memories of the service provider computers. The flow 100 may begin at 102, where product identifiers are created and/or associated with products being offered for sale by the service provider, e.g. an electronic marketplace. Product identifiers may be set, for example, by a product manufacturer and/or seller, and/or may be set by the service provider. In some examples, the product identifiers may uniquely identify individual products, packages of products (e.g. a 4-pack of a certain AA battery), and/or combinations of products offered for sale together.

The flow 100 may continue with 104, where product criteria may be analyzed, for example, to determine whether a product is a candidate for pre-packaging and/or expedited shipping. In some examples, the determination may be based, at least in part, on one or more of item cost, item profit margin, item weight and/or item size. Such criteria may be appropriate in determining whether it makes financial sense for an electronic marketplace to pre-package and/or offer an expedited shipping option for a particular item. As discussed further below, some examples may include offering the expedited shipping for the same cost as another, slower, delivery option. Therefore, the cost differential may be a significant consideration for the electronic marketplace to consider. As will be appreciated, by using combinations of, for example, profit margin and expected shipping costs, products can be analyzed individually, and dynamically, to determine whether an individual item should be a candidate for pre-packaging and/or expedited shipping. In some examples, the determination may be based, at least in part, on a machine learning algorithm, and may be performed iteratively over time, or on demand, e.g. in response to a significant increase in sales, pre-orders, backorders, price, social media traffic or other metric associated with the item.

It should further be understood that, although the present example may refer to pre-packaging and/or expedited shipping as exemplary abbreviated processes, other examples of selective inbound and/or outbound processes that omit steps otherwise included in similar processes performed by the electronic marketplace may also be included.

The flow 100 may continue with 106, in which product metrics and/or projections related to those items determined to be candidates for pre-packaging and/or expedited shipping may be further analyzed to determine whether to implement such processes with respect to received items and/or items already in storage. However, it should be noted that, in some examples, 106 may be performed prior to 104 and/or may be performed for various, or all, products that the electronic marketplace offers.

In some examples, 106 may include assessing one or more of previous sales, expected sales, a number of expedited shipping orders, pre-orders and/or backorders, social media analytics or other criteria (alone or in combination with other factors) to determine whether to flag a product identifier for pre-packaging and/or expedited shipping. The assessment may include application of an algorithm including various weighting factors assigned to one or more of the foregoing criteria. In some examples, 106 may include identifying expected and/or potential future sales for one or more items (such as those items determined to be candidates for the pre-packaging and/or expedited shipping) based at least in part on a forecasting engine.

In some examples, identifying the expected and/or potential future sales in 106 may be based at least in part on social media information associated with the product. In some examples, the social media information may include public comments that identify the product. In some examples, the social media information may be gathered via a computer algorithm that automatically identifies comments associated with a particular item, e.g. by make and/or model name, by thread identifiers, and/or by heuristic algorithms that associate other key words with the make and/or model name or thread identifiers. In some examples, different social media sources may be assigned different weights, and/or different social media sources may be assigned different weights with respect to certain technology categories. For example, certain blogs, or other social media sources, may be particularly insightful with respect to a particular technology/product area, like MP3 players, hair care products or organic foods. Therefore, in some examples, additional weight may be assigned to certain social media sources when assessing product identifiers that are associated with a technology/product area in which the social media source has been found to be a reliable forecaster (e.g. by heuristic or other learning algorithms and machines discussed further herein).

In some examples, 106 may include comparing the results of the product metrics and/or projections to a threshold associated with one or more of the metrics and/or projections. In some embodiments, the threshold may represent a combined value to be compared with the results of an algorithm including one or more of the foregoing criteria (with or without associated weighting factors).

In some examples, when the results of 106 are below the threshold amount, a negative response may be recorded for a particular item, and a first inbound process may continue to be implemented on instances of the particular item as the instances of the particular item arrive at a fulfillment center associated with the electronic marketplace. For example, received items of a product that is not flagged for pre-packaging and/or expedited shipping may be shelved, or otherwise stored, at the fulfillment center without packaging the items for shipping.

In some examples, when the results of 106 are above the threshold amount, a particular item may be designated for pre-packaging and/or expedited shipping, e.g. by flagging a corresponding product identifier in 108. However, as noted above, various methodologies may perform 104 and 106 in isolation, iteratively and/or in differing order. In some example, 106 may be performed before determining whether the item is a candidate pre-packaging and/or expedited shipping. For example, 106 may identify spikes in item sales, pre-orders, backorders and/or high levels of social media interest for a particular product, or predict future spikes in sales (e.g. based on seasonal sales) or backorders (e.g. based on analyzing sales levels and resupply rates) after which, the item may be analyzed in 104 (e.g. based on profit margin, shipping costs, expected sales levels, etc.) to determine whether it is a suitable candidate for pre-packaging and/or expedited shipping.

Accordingly, in some examples, 108 may follow 104, such as when a product is analyzed to determine whether it is a candidate for pre-packaging and/or expedited shipping after being identified as exceeding a threshold in 106. In some examples, a system administrator, or other user, may force an assessment in 104 to provide an “on demand” determination, which can lead to 108 without assessing product metrics and/or projections in 106. Such forcing may be desirable, for example, when a retailor wants to encourage sales of a particular product by providing expedited shipping, or other situations complimented by targeted sales incentives.

The flow 100 may continue with 112 in which a second inbound process may be implemented on instances of designated items as the instances of the designated items arrive at a fulfillment center associated with the electronic marketplace. In some examples, the second inbound process may omit one or more of the shelving/storing steps from the first inbound process, and pre-package the received product for mailing.

Pre-packaging step may include at least partially packaging the designated item for mailing, e.g. one or more of packing, boxing and/or sealing the received product in a mailing container of the electronic marketplace. In some examples, such pre-packaging steps may be performed before the individual item is associated with a purchasing consumer and/or before a purchase order for the individual item is processed.

In some examples, the received instances of the particular item may be packaged in 112 as part of an automated process as the instances of the particular item arrive at a fulfillment center. For example, automated receiving processes may identify received instances of the particular item by product identifier and may automatically route such items to an automated packaging station that pre-packages the item in an appropriate mailing container. In some examples, the automated packaging station may identify the appropriate mailing container based on the product identifier, or other factors, and may facilitate the received items being processed through pre-packaging without user intervention.

In some examples, the pre-packaging process in 112 may be applied to a limited number of the received instances of the particular item. For example, 108 may include identifying a desired number of a particular item to process through pre-packaging (e.g. second process), and the flow 100 may limit the number of the item instances that are processed through 112 based on the desired number. Therefore, in some examples, the item instances processed through 112 can be associated with expedited orders (e.g. one or two day shipping), whereas other instances of the item may be associated with non-expedited orders, which may save on overall costs.

In some examples, the pre-packaging process in 112 may be applied to instances of the particular item that have already been received and that are being shelved or otherwise stored. For example, as mentioned above, certain increases in sales of items may be predicted, e.g. in 106, based on seasonal surges associated with such items. In some examples, it may be advantageous to pre-package some, or all, of the inventory that the electronic marketplace has on hand for such items (which may be initiated via control instructions to various inventory handling means).

The flow 100 may continue with 114, in which an order for the selected product is processed. In some examples, 114 may include various order receiving and processing steps as discussed further herein, e.g. with respect to a customer interaction with a website of the electronic marketplace and/or purchase/payment processing performed by servers associated with the electronic marketplace or other service providers.

In some examples, 114 may include associating a particular item with an order (e.g. identifying the particular item that is going to be shipped to the purchaser associated with a particular order).

The flow 100 may continue with 116, in which a shipping label may be applied to a pre-packaged item. This may be done, for example, after the item is associated with a purchasing consumer and/or after a purchase order for the particular item is processed in 114.

Additional examples are described with reference to flow 200 shown in FIG. 2. Flow 200 may be performed, for example, in the context of an online storefront for a manufacturer and/or retailer, and associated product handling and fulfillment center, such as an electronic marketplace described above. In 202, products may be received, e.g. via shipping from the product manufacturer or distributer. Received products may be identified, for example, via product identifiers as discussed above.

The flow 200 may continue with 204, in which a determination is made as to whether the received product is flagged for pre-packaging. If it is determined that the received product is flagged for pre-packaging in 204, the flow 200 may proceed with 206, in which the received product is pre-packaged, e.g. by packaging the product for shipping prior to shelving or otherwise storing the received product. In some examples, the pre-packaged product may be shelved or stored until an order for the particular product is processed. In some examples, the pre-packaged product may be forwarded for further processing (e.g. labeling and/or shipping) without shelving the pre-packaged product, such as when the received product is being purchased at a rate that the automated order fulfillment and packaging can satisfy without shelving the pre-packaged product.

As noted previously, in some examples, pre-packaging and/or expedited shipping of a particular item may be enabled while current or predicted metrics are above a threshold amount. Therefore, newly received instances of a product may be subject to new determinations in 204, e.g. based on changes in the metrics and/or thresholds over time, and pre-packaging may be applied or stopped dynamically for a given product.

In some examples, once an item is pre-packaged in 206 (or otherwise recognized as available for expedited delivery) an identifier may be provided (on a web page for selling the product) that distinguishes the item from other non-qualifying items (e.g. those items that are not candidates for the pre-packaging, or those that do not qualify based on the further metrics, projections and/or threshold analysis). In some examples, certain users may be presented with the expedited shipping option for a particular item, whereas other users may not be presented with the option, e.g. the service may be restricted to certain categories of users such as preferred members, or may be restricted to users in pre-designated geographic areas.

The flow 200 may continue from 206 to 208, in which an order for the pre-packaged product is processed. In some examples, 208 may include processing new purchase orders and/or fulfilling pre-orders or backorders, from new or existing inventory. For example, as mentioned above, pre-packaged products may be associated with new orders, pre-orders or backorders in 208 immediately, or shortly, after pre-packaging, and/or a plurality of products may be pre-packaged based on an expected increase in sales, and may be associated with new orders as the orders come in and are processed in 208.

The flow 200 may continue from 208 to 220, in which a shipping/mailing label may be applied to the pre-packaged product associated with the order processed in 208. Various ways of labeling packages for shipping are known in the art and are not discussed in excessive detail herein.

Returning to 204, if it is determined that the received product is not flagged for pre-packaging, the flow 200 may proceed from 204 to 212, in which the received product is shelved or otherwise stored prior to packaging for shipment to a purchaser.

In some examples, stored products may be identified for pre-packaging and the flow 200 may proceed from 212 to 206 for such products. For example, as discussed previously, identifying designated products for expedited processing may be an iterative and/or on-demand process, whereby the electronic marketplace designates certain products that they may already have in inventory. Accordingly, in some instances, exemplary systems and methods may retrieve designated products that are stored in inventory to pre-package the products for expedited order processing and/or delivery. In some examples, the designated products may be withdrawn from shelving/storage for pre-packaging prior to being associated with a particular customer order.

Returning to 212, in some examples, stored products that have not been pre-packaged may be associated with orders processed in 214. Such processing may be included in operations for implementing a first inbound process, e.g. receiving items, identifying the items, stowing the items, picking the stowed items, and packaging the picked items.

In some examples, order processing in 214 may include a customer selection that they do not want expedited (e.g. one-day, overnight or two-day) shipping, whereby the electronic marketplace may access stored, unpackaged, products that do not require the abbreviated processing necessary for expedited shipping.

The flow 200 may continue from 214 to 216, in which an unpackaged product associated with the order processed in 214 may be retrieved from shelf/storage and packaged for shipping.

The flow 200 may continue from 216 to 222, in which a shipping/mailing label may be applied to the packaged product associated with the order processed in 214. Various ways of labeling packages for shipping are known in the art and are not discussed in excessive detail herein.

It should be appreciated that aspects of the foregoing processes may advantageously provide for pre-packaging of selected products and help to expedite shipping of such products when orders are processed, and/or may reduce processing and handling costs associated with first receiving and shelving products, and thereafter retrieving and packaging the products after orders for the products are received. For example, by applying aspects of the foregoing processes to designate and handle high-demand products (which may have a corresponding demand for expedited delivery), such products may be received, packaged and shipped to a purchaser in a reduced period of time, for reduced cost. This can, in turn, encourage additional sales for “impulse purchases,” pre-ordered and/or backordered products, and other situations where purchasers value rapid delivery.

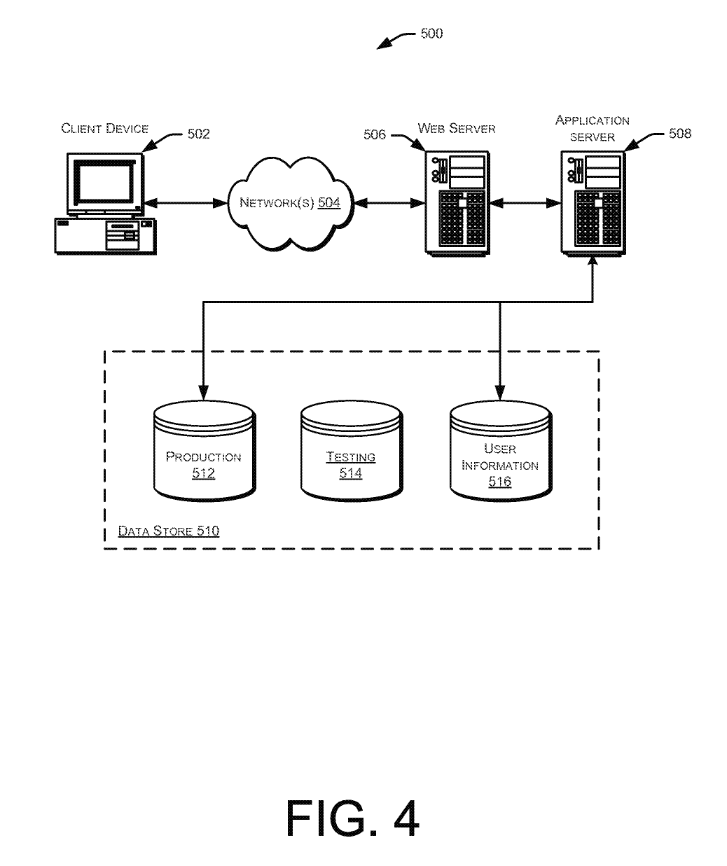

Illustrative methods and systems for implementing examples of the present disclosure are described above. Some or all of these systems and methods may, but need not, be implemented at least partially by architectures and processes such as those shown at least in FIGS. 3 and 4, which are described below.

FIG. 3 depicts an illustrative system or architecture 300 in which techniques for processing product orders as described herein may be implemented. In architecture 300, one or more customers and/or users 302 (e.g., account holders of an electronic marketplace service) may utilize user computing devices 304(1)-(N) (collectively, “user devices 304”) to access a network browser 306 (e.g., a web browser), via one or more networks 308. In some aspects, the web browser 306 may provide network content that may be hosted, managed, and/or otherwise provided by a service provider. In some examples, a customer may own, manage, operate, control, or otherwise be responsible (e.g., financially) for one or more accounts, groups of accounts, and/or sub-groups of accounts. The one or more service provider computers 310 may, in some examples, provide computing resources such as, but not limited, web hosting, client entities, data storage, data access, management, virtualization, etc. In some aspects, a processing entity may be virtual and/or data volumes may be stored virtually within a distributed computing system operated by the one or more service provider computers 302. The one or more service provider computers 302 may also be operable to provide web hosting, computer application development, and/or implementation platforms, combinations of the foregoing, or the like to the one or more users 302. Additionally, in some examples, the one or more service provider computers 302 may be associated with or otherwise utilized to manage a service provider (e.g., a company or other business entity) that provides an electronic marketplace of digital and/or physical items. The service provider may also manage a fulfillment center (e.g., a warehouse that stores physical items that may be capable of fulfilling orders for the items by shipping the items or scheduling shipment of the items) and/or a brick-and-mortar store.

In some examples, the networks 308 may include any one or a combination of many different types of networks, such as cable networks, the Internet, wireless networks, cellular networks, and other private and/or public networks. While the illustrated example represents the users 302 accessing the web service application 306 over the networks 308, the described techniques may equally apply in instances where the users 302 interact with the service provider computers 302 via the one or more user devices 304 over a landline phone, via a kiosk, or in any other manner. It is also noted that the described techniques may apply in other client/server arrangements (e.g., set-top boxes, etc.), as well as in non-client/server arrangements (e.g., locally stored applications, etc.).

In one illustrative configuration, the user devices 304 may include at least one memory 314 and one or more processing units (or processor(s)) 315. The processor(s) 315 may be implemented as appropriate in hardware, computer-executable instructions, firmware, or combinations thereof. Computer-executable instruction or firmware implementations of the processor(s) 315 may include computer-executable or machine-executable instructions written in any suitable programming language to perform the various functions described.

The memory 314 may store program instructions that are loadable and executable on the processor(s) 315, as well as data generated during the execution of these programs. Depending on the configuration and type of user device 304, the memory 314 may be volatile (such as random access memory (RAM)) and/or non-volatile (such as read-only memory (ROM), flash memory, etc.). The user device 304 may also include additional removable storage and/or non-removable storage including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory 314 may include multiple different types of memory, such as static random access memory (SRAM), dynamic random access memory (DRAM), or ROM.

Turning to the contents of the memory 314 in more detail, the memory 314 may include an operating system and one or more application programs or services for implementing at least the web browser 306 as well as other features disclosed herein. Additionally, the memory 314 may store access credentials and/or other user information such as, but not limited to, user IDs, passwords, and/or other user information. In some examples, the user information may include information for authenticating an account access request such as, but not limited to, a device ID, a cookie, an IP address, a location, or the like. In addition, the user information may include a user-provided response to a security question or a geographic location obtained by the user device 304.

As described briefly above, the web browser 306 may allow the users 302 to interact with a service provider computer 310, such as to view, review, rate, order, and/or purchase items and/or other content. The one or more service provider computers 310, perhaps arranged in a cluster of servers or as a server farm, may host the content displayed by the web browser 306. Other server architectures may also be used to host the web browser 306. The web browser 306 may be capable of handling requests from many users 302 and serving, in response, various user interfaces that can be rendered at the user devices 304 such as, but not limited to an electronic catalog of items offered or otherwise provided (e.g., in advertisements or the like) by an electronic marketplace. The web browser 306 can display any type of website that supports user interaction, including social networking sites, online retailers, informational sites, blog sites, search engine sites, news and entertainment sites, and so forth. As discussed above, the described techniques can similarly be implemented outside of the web browser 306, such as with other applications running on the user devices 304.

In some examples, an electronic marketplace may be managed by one or more service provider computer 310 that host electronic content in the form of an electronic catalog. Customers may access the electronic catalog to view, review, discuss, order, and/or purchase items (e.g., physical items that may be stored in a warehouse or other location) from the electronic marketplace. In some examples, the service provider computer 310 may be configured to support different levels of membership for different customers, each level of membership potentially being associated with different ordering and/or shipping processes. Additionally, the electronic marketplace may provide (e.g., in digital form via the server and/or by arranging for the items to be physically shipped) items of different prices.

In some examples, service provider computer 310 may be configured to manage processes for receiving, packaging and/or fulfilling orders for items offered by the electronic marketplace. In some examples, the service provider computer 310 may support a number of different inbound and/or outbound processes for items, at least some of which may be implemented using less steps than similar processes, as described further herein.

In some examples, service provider computer 310 may be configured to manage automated techniques for receiving, sorting, pre-packaging, storing, retrieving, and/or labeling products and/or shipping containers in an automated fulfillment warehouse, as also described herein.

In some examples, the service provider computers 310 may also be any type of computing devices such as, but not limited to, mobile, desktop, thin-client, and/or cloud computing devices, such as servers. In some examples, the service provider computers 310 may be in communication with the user devices 304 and/or the third-party service provider computers 316 via the networks 308, or via other network connections. The service provider computers 310 may include one or more servers, perhaps arranged in a cluster, as a server farm, or as individual servers not associated with one another. These servers may be configured to host a website (or combination of websites) viewable via the user devices 304 or the web browser 306 accessible by a user 302. Additionally, in some aspects, the service provider computers 310 may be configured to perform analytics related to identifying products that may be candidates for pre-packaging and/or expedited shipping as part of an integrated, distributed computing environment and automated fulfillment center.

In one illustrative configuration, the service provider computers 310 may include at least one memory 418 and one or more processing units (or processor(s)) 424. The processor(s) 424 may be implemented as appropriate in hardware, computer-executable instructions, firmware, or combinations thereof. Computer-executable instruction or firmware implementations of the processor(s) 424 may include computer-executable or machine-executable instructions written in any suitable programming language to perform the various functions described.

The memory 418 may store program instructions that are loadable and executable on the processor(s) 424, as well as data generated during the execution of these programs. Depending on the configuration and type of service provider computers 310, the memory 418 may be volatile (such as random access memory (RAM)) and/or non-volatile (such as read-only memory (ROM), flash memory, etc.). The service provider computers 310 or servers may also include additional storage 426, which may include removable storage and/or non-removable storage. The additional storage 426 may include, but is not limited to, magnetic storage, optical disks, and/or tape storage. The disk drives and their associated computer-readable media may provide non-volatile storage of computer-readable instructions, data structures, program modules, and other data for the computing devices. In some implementations, the memory 418 may include multiple different types of memory, such as static random access memory (SRAM), dynamic random access memory (DRAM), or ROM.

The memory 418, the additional storage 426, both removable and non-removable, are all examples of computer-readable storage media. For example, computer-readable storage media may include volatile or non-volatile, removable or non-removable media implemented in any method or technology for storage of information such as computer-readable instructions, data structures, program modules, or other data. The memory 418 and the additional storage 426 are all examples of computer storage media. Additionally, the memory 418 and other envisioned memory devices of the service provider computers 310 are intended to cover systems where the different memory devices may be distributed among multiple host computing systems. For example, the memory 418 may be implemented by a first host device of the service provider computers 310, while other memory devices may be implemented by a second (and different) host device of the service provider computers 310. Further, one or more different modules and/or sets of modules may be implemented by different hosts, in some examples, even located in different locations and/or on different racks. For example, one or more application programs or services implemented by the service provider computers 310 may each be implemented by different host computing devices, or the like.

The service provider computers 310 may also contain communications connection(s) 428 that allow the service provider computers 310 to communicate with a stored database, another computing device or server, user terminals, and/or other devices on the networks 308.

The service provider computers 310 may also include input/output (I/O) device(s) 430, such as a keyboard, a mouse, a pen, a voice input device, a touch input device, a display, speakers, a printer, etc.

Turning to the contents of the memory 418 in more detail, the memory 418 may include an operating system 432 and the one or more application programs or services for implementing the features disclosed herein including a user application/account management module 434, a candidate determination module 436, a metrics analysis module 438, a monitoring module 440 and/or a handling module 442.

The user application/account management module 434 may be configured to generate, host, or otherwise provide a website for accessing the service provider computers 310 and/or the electronic marketplace. In some examples, the user application/account management module 434 may also be configured to maintain, or otherwise store, account information associated with requested network content. The account information may include account holder information, the user ID, the password, acceptable answers to challenge questions, etc. In some examples, the service provider computer may be configured to present different options relevant to prepackaged and/or expedited shipping options to different users. For example, one level of user may be provided the option of ordering pre-packaged items for expedited shipping at no additional cost, compared to a slower option, whereas other user levels may be presented the option of ordering pre-packaged items for expedited shipping at an additional cost.

Additionally, as noted above, each of the aforementioned modules 432, 434, 436, 438, 440 and/or 442 may be implemented or otherwise provided by different host computing devices of the service provider computers 310.

In some aspects, the candidate determination module 436 may be configured to identify one or more available products offered by the electronic marketplace as a candidate for pre-packaging, or other abbreviated inbound and/or outbound process. In some examples, the determination may be based, at least in part, on one or more of item cost, item profit margin, item weight and/or item size. In some examples, the determination may be based, at least in part, on a machine learning algorithm, which may be executing within the candidate determination module 436. In some examples, the candidate determination module 436 may be called to make a determination based on the metrics analysis module 438 identifying an otherwise qualifying product and/or by a direct request from an administrator or other user.

In some aspects, the metrics analysis module 438 may be configured to analyze metrics and/or projections related to one or more available products offered by the electronic marketplace. The metrics analysis module 438 may analyze information related to products determined to be candidates for pre-packaging by the candidate determination module 436, all physical products offered by the electronic marketplace, or other subset of products offered by the electronic marketplace.

In some aspects, the metrics analysis module 438 may generate one or more learning models (e.g. machine learning algorithm models) including a machine instance 444 with a forecasting engine for predicting expected sales of various products, such as products determined to be candidates for pre-packaging by the candidate determination module 436. Machine instance 444 may analyze pre-orders, historical sales, and other data, maintained in data store 448, or other accessible source, e.g. via online monitor 450.

In some aspects, the metrics analysis module 438 may be configured to receive purchase history information associated with a plurality of items offered by the electronic marketplace, and/or generate forecasted purchase information for at least one item of the plurality of items offered by the electronic marketplace. In some examples, the forecasted purchase information may be based at least in part on the purchase history information stored in data store 448. Additionally, in some examples, the system may determine a threshold amount of potential sales for at least a subset of the plurality of items. In some examples, the threshold amount may identify whether to enable an expedited shipping program.

Additionally, in some examples, the metrics analysis module 438 may identify when the forecasted purchase information for an item exceeds a threshold amount, and implement an expedited shipping program for the item, via handling module 442, based at least in part on identifying that the forecasted purchase information for the item exceeds the threshold amount.

Monitoring module 440 may be configured to provide up to date information to the metrics analysis module 438 and may gather such information, for example, from an online monitor 450, which may include various search engine algorithms, e.g. for gathering social media information, related sales information, or other information relevant to predicting sales for particular products and/or other objects described herein.

The machine learning algorithms included in any of modules 436, 438, 440, machine instance 444, or monitor 450 may be able to adapt over time determining which data is more of less useful (e.g. based on historical determinations and subsequent sales date), and may adjust weighting factors as appropriate.

Some examples of purchase history data and/or features that may be provided to the machine learning algorithms to generate the models include, but are not limited to, a number of items purchased over a particular period of time (e.g., 30 days, a year, etc.), an average sales price of items purchased, a number of days gap between purchases, an average sales price of total orders, etc. Examples of machine learning algorithms that may be appropriate are known in the art and include, but are not limited to, random forest, generalized linear models, etc.

In some examples, the analysis provided by modules 436 and/or 438 may include reference to one or more preset thresholds, as described further herein. In some examples, modules 436 and/or 438 may be configured to adjust such thresholds based on machine learning algorithms included therein. For example, certain thresholds related to particular metrics may be found, over time, to more accurately predict certain types of product sales (e.g. social media metrics and electronics products). Accordingly, particular thresholds for certain types of products, or other categories, may be adjusted over time, to allow for more accurate or inclusive sales predictions.

In some examples, the handling module 442 may be in communication with one or more fulfillment center computers (not shown). The fulfillment center computers may be integrated with the service provider computers 310, for example, when the service provider provides fulfillment services as well. However, in some examples, the fulfillment center computers may be affiliated with a separate fulfillment center or other entity that manages fulfillment and/or shipping of items. Nevertheless, the handling module 442 may be configured to provide instructions to, and/or exchange information with, the fulfillment service provider computers or to other services based on the determination to pre-package and/or make certain products available for expedited handling, as discussed further herein. For example, the instructions may instruct the fulfillment center to pre-package received items of a certain product identifier, pre-package stored inventory of a certain product identifier, pre-package a certain number of a certain product identifier, etc.

In some examples, the service provider computer 310 may be configured to provide an indicator that a certain product is available for expedited shipping (e.g. one day, overnight and/or two day shipping) based on one or more of confirmation data received from the fulfillment center, a pre-packaging instruction sent to the fulfillment center, and/or a determination by the candidate determination module and/or the metrics analysis module that a product qualifies for pre-packaging and/or expedited shipping.

In some aspects, the service provider computers 310 may generate one or more purchase history models and store the purchase history models in a model data store 448. As noted above, such purchase history models may be used in the implementation of one or more machine learning algorithms, or other learning models, that can be configured to predict sales levels or other metrics, and that may be improved upon once the models are trained using previous data. In some examples, the models may be configured to receive data and/or features associated with the electronic marketplace and/or purchase history information associated with customers of the electronic marketplace. The models may be configured to adapt over time based at least in part on new data; training themselves to incorporate new data once deemed relevant and/or stop using data that they determine to be irrelevant.

FIG. 4 illustrates aspects of an example environment 500 for implementing aspects in accordance with various embodiments. As will be appreciated, although a Web-based environment is used for purposes of explanation, different environments may be used, as appropriate, to implement various embodiments. The environment includes an electronic client device 502, which can include any appropriate device operable to send and receive requests, messages, or information over an appropriate network 504 and convey information back to a user of the device. Examples of such client devices include personal computers, cell phones, handheld messaging devices, laptop computers, set-top boxes, personal data assistants, electronic book readers, and the like. The network can include any appropriate network, including an intranet, the Internet, a cellular network, a local area network or any other such network or combination thereof. Components used for such a system can depend at least in part upon the type of network and/or environment selected. Protocols and components for communicating via such a network are well known and will not be discussed herein in detail. Communication over the network can be enabled by wired or wireless connections and combinations thereof. In this example, the network includes the Internet, as the environment includes a Web server 506 for receiving requests and serving content in response thereto, although for other networks an alternative device serving a similar purpose could be used as would be apparent to one of ordinary skill in the art.

The illustrative environment includes at least one application server 508 and a data store 510. It should be understood that there can be several application servers, layers, or other elements, processes or components, which may be chained or otherwise configured, which can interact to perform tasks such as obtaining data from an appropriate data store. As used herein the term “data store” refers to any device or combination of devices capable of storing, accessing, and/or retrieving data, which may include any combination and number of data servers, databases, data storage devices and data storage media, in any standard, distributed or clustered environment. The application server can include any appropriate hardware and software for integrating with the data store as needed to execute aspects of one or more applications for the client device, handling a majority of the data access and business logic for an application. The application server provides access control services in cooperation with the data store, and is able to generate content such as text, graphics, audio and/or video to be transferred to the user, which may be served to the user by the Web server in the form of HTML, XML or another appropriate structured language in this example. The handling of all requests and responses, as well as the delivery of content between the client device 502 and the application server 508, can be handled by the Web server. It should be understood that the Web and application servers are not required and are merely example components, as structured code discussed herein can be executed on any appropriate device or host machine as discussed elsewhere herein.

The data store 510 can include several separate data tables, databases or other data storage mechanisms and media for storing data relating to a particular aspect. For example, the data store illustrated includes mechanisms for storing production data 512 and user information 516, which can be used to serve content for the production side. The data store also is shown to include a mechanism for storing log data 514, which can be used for reporting, analysis, or other purposes such as those described herein. It should be understood that there can be many other aspects that may need to be stored in the data store, such as for page image information and to access right information, which can be stored in any of the above listed mechanisms as appropriate or in additional mechanisms in the data store 510. The data store 510 is operable, through logic associated therewith, to receive instructions from the application server 508 and obtain, update or otherwise process data in response thereto. In one example, a user might submit a search request for a certain type of item. In this case, the data store might access the user information to verify the identity of the user, and can access the catalog detail information to obtain information about items of that type. The information then can be returned to the user, such as in a results listing on a Web page that the user is able to view via a browser on the user device 502. Information for a particular item of interest can be viewed in a dedicated page or window of the browser.

Each server typically will include an operating system that provides executable program instructions for the general administration and operation of that server, and typically will include a computer-readable storage medium (e.g., a hard disk, random access memory, read only memory, etc.) storing instructions that, when executed by a processor of the server, allow the server to perform its intended functions. Suitable implementations for the operating system and general functionality of the servers are known or commercially available, and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 4. Thus, the depiction of the system 500 in FIG. 4 should be taken as being illustrative in nature, and not limiting to the scope of the disclosure.

The various embodiments further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including HTTP servers, FTP servers, CGI servers, data servers, Java servers, and business application servers. The server(s) also may be capable of executing programs or scripts in response requests from user devices, such as by executing one or more Web applications that may be implemented as one or more scripts or programs written in any programming language, such as Java®, C, C# or C++, or any scripting language, such as Perl, Python or TCL, as well as combinations thereof. The server(s) may also include database servers, including without limitation those commercially available from Oracle®, Microsoft®, Sybase® and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen or keypad), and at least one output device (e.g., a display device, printer or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.) and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, EEPROM, flash memory or other memory technology, CD-ROM, DVD or other optical storage, magnetic cassettes, magnetic tape, magnetic disk storage or other magnetic storage devices or any other medium which can be used to store the desired information and which can be accessed by the a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

1-15. (canceled)

16. A system, comprising:
a memory that stores computer-executable instructions; and
a processor configured to access the memory, the processor configured to access the memory and execute the computer-executable instructions to collectively at least:
receive purchase history information associated with an identifier that corresponds to a plurality of same commodity items;
forecast a future purchase prediction for the identifier based at least in part on the purchase history information and social media information from a plurality of social media sources, portions of the social media information weighted based at least in part on a respective social media source of the plurality of social media sources and a category of item associated with the plurality of same commodity items, the category of item identified based at least in part on a heuristic algorithm that associates key words in the portions of the social media information with the category of item;
determine when the future purchase prediction identifies that the identifier has a demand above a threshold demand for a first portion of the same commodity items of the plurality of the same commodity items based at least in part on identifying the threshold demand using a first shipping cost, a first shipping distance, and a first weight of the portion of the same commodity items in comparison to a second shipping cost, a second shipping distance, and a second weight of a second portion of the same commodity items of the plurality of the same commodity items; and
prepackage at least a subset of the plurality of same commodity items for expedited shipping based at least in part on the demand being above the threshold demand prior to receiving an order for the subset of the plurality of same commodity items.

17. The system of claim 16, wherein the plurality of the same commodity items is available in an electronic marketplace.

18. The system of claim 16, wherein the identifier identifies each of the same commodity item.

19. The system of claim 16, wherein the purchase history information is collected over time and corresponds to past purchases, by customers of the electronic marketplace, of the plurality of same commodity items.

20. A non-transitory computer-readable storage device storing computer-executable instructions that, when executed by one or more computer systems, configure the one or more computer systems to perform operations comprising:
forecasting a future purchase volume for an item based at least in part on purchase history information corresponding to equivalent items and social media information corresponding to the equivalent items from a plurality of social media sources, portions of the social media information weighted based at least in part on a respective social media source of the plurality of social media sources and a category of item associated with the equivalent items, the category of item identified based at least in part on a heuristic algorithm that associates key words in the portions of social media information with the category of item;
enabling an expediting inbound process for receiving the item from a seller based at least in part on the future purchase volume being above a threshold amount, the threshold amount identified using a first shipping cost, a first shipping distance, and a first weight of the item in comparison to a second shipping cost, a second shipping distance, and a second weight of the equivalent items; and
prepackaging the item for expedited shipping based at least in part on the future purchase volume being above the threshold amount prior to receiving an order for the item.

21. The non-transitory computer-readable storage device of claim 20, wherein the social media information identifies a level of public demand for the item, and wherein the forecasted future purchase volume includes a weighted amount of the social media information.

22. The non-transitory computer-readable storage device of claim 20, wherein the forecasted future purchase volume is further based at least in part on seasonal purchase variability information corresponding to the item.

23. The non-transitory computer-readable storage device of claim 20, wherein the instructions further configure the one or more computer systems to perform operations comprising enabling a customer to search for the prepackaged item based at least in part on the prepackaged item being available for expedited shipping.

24. A computer-implemented method, comprising:
receiving purchase history information associated with an identifier that corresponds to a plurality of same commodity items offered by an electronic marketplace;
determining, by a computer processor, a threshold amount associated with the identifier, the threshold amount identifying whether to enable a preemptive process for expedited shipping;
forecasting, by a computer processor, a future purchase prediction for the identifier based at least in part on the purchase history information and social media information from a plurality of social media sources, portions of the social media information weighted based at least in part on a respective social media source of the plurality of social media sources and a category of item associated with the plurality of same commodity items, the category of item identified based at least in part on a heuristic algorithm that associates key words in the portions of the social media information with the category of item;
determining, by a computer processor, when the future purchase prediction identifies that the identifier has a demand above the threshold demand for a first portion of the same commodity items of the plurality of the same commodity items based at least in part on identifying the threshold demand using a first shipping cost, a first shipping distance, and a first weight of the portion of the same commodity items in comparison to a second shipping cost, a second shipping distance, and a second weight of a second portion of the same commodity items of the plurality of the same commodity items; and
prepackaging, at a fulfillment center associated with the electronic marketplace, at least a subset of the plurality of same commodity items for expedited shipping based at least in part on the demand being above the threshold demand prior to receiving an order for the subset of the plurality of same commodity items.

25. (canceled)

26. The computer-implemented method of claim 25, wherein the social media information identifies a level of public demand for the item.

27. The computer-implemented method of claim 24, wherein the purchase history information is collected over time and corresponds to past purchases, by customers of the electronic marketplace, of the plurality of same commodity items.

28. The computer-implemented method of claim 24, wherein forecasting the future purchase prediction for the identifier is further based at least in part on seasonal purchase variability information corresponding to the item.

29. The computer-implemented method of claim 24, further comprising enabling a customer to search the electronic marketplace for the prepackaged item based at least in part on the prepackaged item being available for expedited shipping.

30. The computer-implemented method of claim 24, wherein the process for expedited shipping includes prepackaging received instances of the same commodity items as part of an automated process as the instances of the same commodity items arrive at the fulfillment center.

31. The computer-implemented method of claim 24, wherein the threshold amount is determined dynamically based at least in part on at least one of a cost of each item, a profit associated with each item, or a size of each item.

32. The computer-implemented method of claim 24, further comprising determining, based at least in part on a machine learning algorithm, whether the same commodity items are candidates for the preemptive process for expedited shipping.

33. The system of claim 16, wherein the processor is further configured to determine, based at least in part on a machine learning algorithm, whether the same commodity items are candidates for the prepackaging.

34. The non-transitory computer-readable storage device of claim 20, further comprising executable instructions for determining, based at least in part on a machine learning algorithm, whether the item is a candidate for the prepackaging.
